(19) United States
(12) Patent Application Publication
(10) Pub. No.: US 2014/0293300 A1
(43) Pub. Date: Oct. 2, 2014

(54) PRINTING CONDITION SETTING APPARATUS, PRINTING CONDITION SETTING METHOD, AND NON-TRANSITORY STORAGE MEDIUM

(71) Applicant: FUJIFILM Corporation, Tokyo (JP)

(72) Inventor: Eiji TERAUE, Tokyo (JP)

(73) Assignee: FUJIFILM Corporation, Tokyo (JP)

(21) Appl. No.: 14/183,795

(22) Filed: Feb. 19, 2014

(30) Foreign Application Priority Data
Mar. 28, 2013 (JP) 2013-068783

(51) Int. Cl. G06K 15/02

(52) U.S. Cl. CPC G06K 15/1878
USPC 358/1.9

(57) ABSTRACT

It is detected whether or not a print medium supplied to a printing apparatus has been replaced with a print medium of the same medium type within a period of time from a preceding calibration execution time to a present calibration execution time. A representative condition corresponding to a color conversion condition that is obtained at the present calibration execution time is corrected depending on the detected result. Based on the corrected representative condition, color conversion conditions corresponding to two or more medium types that belong to the same group as the representative type are corrected collectively.

### CROSS-REFERENCE TO RELATED APPLICATION

This application is based upon and claims the benefit of priority from Japanese Patent Application No. 2013-068783 filed on Mar. 28, 2013, the contents of which are incorporated herein by reference.

### BACKGROUND OF THE INVENTION

1. Field of the Invention

The present invention relates to a printing condition setting apparatus, a printing condition setting method, and a non-transitory storage medium for setting color conversion conditions for respective types of print mediums.

2. Description of the Related Art

Heretofore, it has been customary for the steady production of prints of stable quality, which suffer from minimum color fluctuations, to have a calibration process appropriately carried out by respective printers. Recently, digitization of printing workflows has become so popular that a color matching technology based on color profiles (hereinafter also referred to as “profiles”) is in widespread use.

In the case that prints are produced by a single printing apparatus, if the prints are formed on different types of print mediums (hereinafter also referred to as “medium types”), then the prints may have significantly different color reproduction characteristics. In other words, for strict color precision management, it is necessary to generate and prepare as many profiles as the number of medium types involved. However, it is tedious and time-consuming for the operator to fulfill such a task.

To alleviate the aforementioned shortcomings, Japanese Laid-Open Patent Publication No. 2011-009920, Japanese Laid-Open Patent Publication No. 2010-147609, and Japanese Laid-Open Patent Publication No. 2005-176003 have proposed various setting methods in which a plurality of medium types are grouped together, and a calibration result is reflected on a medium type in the remaining other medium types of the group, thereby reducing the number of calibration process steps, or more specifically, the number of calibrations that need to be carried out. Japanese Laid-Open Patent Publication No. 2005-176003 states in paragraph [0031] that problems do not arise out of assuming representative color reproduction characteristics for print mediums that have similar color reproduction characteristics.

### SUMMARY OF THE INVENTION

According to a study conducted by the inventor of the present invention, it has been found that even print mediums under the same brand have significantly different color reproduction characteristics, if the print mediums have different production lot numbers or have different elapsed times due to the production thereof. The setting methods disclosed in Japanese Laid-Open Patent Publication No. 2011-009920, Japanese Laid-Open Patent Publication No. 2010-147609, and Japanese Laid-Open Patent Publication No. 2005-176003 do not take into consideration the above problems. If the disclosed setting methods are applied without modification, then the color reproduction characteristics of prints based on the remaining medium types may possibly be impaired.

It is an object of the present invention to provide a printing condition setting apparatus, a printing condition setting method, and a non-transitory storage medium, which are capable of minimizing the number of required calibration process steps, while at the same time maintaining a desired level of color precision management for prints using print mediums of the same medium type.

According to the present invention, there is provided a printing condition setting apparatus for setting color conversion conditions for respective types of print mediums on which an image is produced with a printing apparatus, comprising a representative type selector for selecting a representative type to be used in a calibration on the printing apparatus from among two or more medium types that have been classified into a group, a replacement detector for detecting whether or not the print medium supplied to the printing apparatus has been replaced with a print medium of the same medium type within a period of time from a preceding calibration execution time to a present calibration execution time, and a color conversion condition updater for correcting a representative condition, which is a color conversion condition corresponding to the representative type that is obtained at the present calibration execution time, depending on a detected result from the replacement detector, and collectively updating color conversion conditions corresponding to two or more medium types that belong to the same group as the representative type, based on the corrected representative condition.

Since the printing condition setting apparatus includes the replacement detector that detects whether or not the print medium supplied to the printing apparatus has been replaced with a print medium of the same medium type within a period of time from a preceding calibration execution time to a present calibration execution time, and the color conversion condition updater that corrects the representative condition, which is a color conversion condition corresponding to the representative type that is obtained at the present calibration execution time, depending on a detected result from the replacement detector, a change in color reproduction characteristics caused by replacement of the print medium can be reflected not only in the representative type, but also in a calibration that is performed on the other medium type. Further, since the color conversion condition updater collectively updates color conversion conditions corresponding to two or more medium types that belong to the same group as the representative type, based on the corrected representative condition, the number of calibrations that are required to be carried out can be reduced to one per group. Consequently, it is possible to minimize the number of required calibration process steps, while at the same time maintaining a desired level of color precision management for prints using print mediums of the same medium type.

Preferably, the replacement detector detects whether or not the print medium of the representative type has been replaced, and the color conversion condition updater corrects the representative condition so as to cancel out a color fluctuation after the print medium of the representative type has been replaced, and collectively updates the color conversion conditions, if the print medium of the representative type is detected as being replaced.

Preferably, the replacement detector detects whether or not a print medium of another medium type apart from the representative type has been replaced, and the color conversion condition updater corrects the corrected representative condition so as to cancel out a color fluctuation caused after the print medium of the other medium type has been replaced, and collectively updates the color conversion conditions if the print medium of the representative type is detected as being replaced and the print medium of the other medium type is detected as being replaced.

Preferably, the replacement detector detects whether or not a print medium of another medium type apart from the representative type has been replaced, and the color conversion condition updater corrects the representative condition so as to cancel out a color fluctuation caused after the print medium of the other medium type has been replaced, and collectively updates the color conversion conditions, if the print medium of the other medium type is detected as being replaced.

Preferably, in the printing condition setting apparatus, the color fluctuation is represented by a color difference of a base of the print medium before and after the print medium is replaced.

According to the present invention, there is also provided a printing condition setting method to be carried out by a printing condition setting apparatus for setting color conversion conditions for respective types of print mediums on which an image is produced with a printing apparatus, comprising the steps of selecting a representative type to be used in a calibration on the printing apparatus from among two or more medium types that have been classified into a group, detecting whether or not the print medium supplied to the printing apparatus has been replaced with a print medium of the same medium type within a period of time from a preceding calibration execution time to a present calibration execution time, and correcting a representative condition, which is a color conversion condition corresponding to the representative type that is obtained at the present calibration execution time, depending on a detected result from the step of detecting, and collectively updating color conversion conditions corresponding to two or more medium types that belong to the same group as the representative type, based on the corrected representative condition.

Preferably, the step of detecting detects whether or not the print medium of the representative type has been replaced, and the step of correcting corrects the representative condition so as to cancel out a color fluctuation after the print medium of the representative type has been replaced, and collectively updates the color conversion conditions, if the print medium of the representative type is detected as being replaced.

Preferably, the step of detecting detects whether or not a print medium of another medium type apart from the representative type has been replaced, and the step of correcting corrects the corrected representative condition so as to cancel out the color fluctuation caused after the print medium of the other medium type has been replaced, and collectively updates the color conversion conditions, if the print medium of the representative type is detected as being replaced and the print medium of the other medium type is detected as being replaced.

Preferably, the step of detecting detects whether or not a print medium of another medium type apart from the representative type has been replaced, and the step of correcting corrects the corrected representative condition so as to cancel out a color fluctuation caused after the print medium of the other medium type has been replaced, and collectively updates the color conversion conditions, if the print medium of the other medium type is detected as being replaced.

Preferably, in the printing condition setting method, the color fluctuation is represented by a color difference of a base of the print medium before and after the print medium is replaced.

According to the present invention, there is further provided a non-transitory storage medium storing therein a program for setting color conversion conditions for respective types of print mediums on which an image is produced with a printing apparatus, the program enabling a computer to carry out the steps of selecting a representative type to be used in a calibration on the printing apparatus from among two or more medium types that have been classified into a group, detecting whether or not the print medium supplied to the printing apparatus has been replaced with a print medium of the same medium type within a period of time from a preceding calibration execution time to a present calibration execution time, and correcting a representative condition, which is a color conversion condition corresponding to the representative type that is obtained at the present calibration execution time, depending on a detected result from the step of detecting, and collectively updating color conversion conditions corresponding to two or more medium types that belong to the same group as the representative type, based on the corrected representative condition.

With the printing condition setting apparatus, the printing condition setting method, and the non-transitory storage medium according to the present invention, since it is detected whether or not the print medium supplied to the printing apparatus has been replaced with a print medium of the same medium type within a period of time from a preceding calibration execution time to a present calibration execution time, and the representative condition that is obtained at the present calibration execution time is corrected depending on the detected result, a change in color reproduction characteristics caused by replacement of the print medium can be reflected not only in the representative type, but also in a calibration that is performed on the other medium type. Further, since color conversion conditions corresponding to two or more medium types that belong to the same group as the representative type are corrected collectively based on the corrected representative condition, the number of calibrations that are required to be carried out can be reduced to one per group. Consequently, it is possible to minimize the number of required calibration process steps, while at the same time maintaining a desired level of color precision management for prints using print mediums of the same medium type.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a print production system incorporating a raster image processor (RIP) as a printing condition setting apparatus according to an embodiment of the present invention;

FIG. 2 is a front elevational view of a color chart shown in FIG. 1;

FIG. 3 is an electric block diagram of the RIP shown in FIG. 1;

FIG. 4 is a flowchart of an operation sequence of the RIP shown in FIGS. 1 and 3;

FIG. 5 is a view of an image showing a setting screen by way of example;

FIG. 6 is a time sequence diagram showing times at which a calibration is performed and times at which a print medium is replaced; and

FIG. 7A is a graph showing color reproduction characteristic curves obtained in the case that print mediums of the same medium type are used; and

FIG. 7B is a graph showing by way of example corrective quantities determined in view of a difference between the color reproduction characteristic curves shown in FIG. 7A.

### DESCRIPTION OF THE PREFERRED EMBODIMENTS

A printing condition setting method according to a preferred embodiment of the present invention in relation to a printing condition setting apparatus, a non-transitory storage medium, and a print production system for carrying out the printing condition setting method will be described in detail below with reference to the accompanying drawings.

### [Configuration of Print Production System 10]

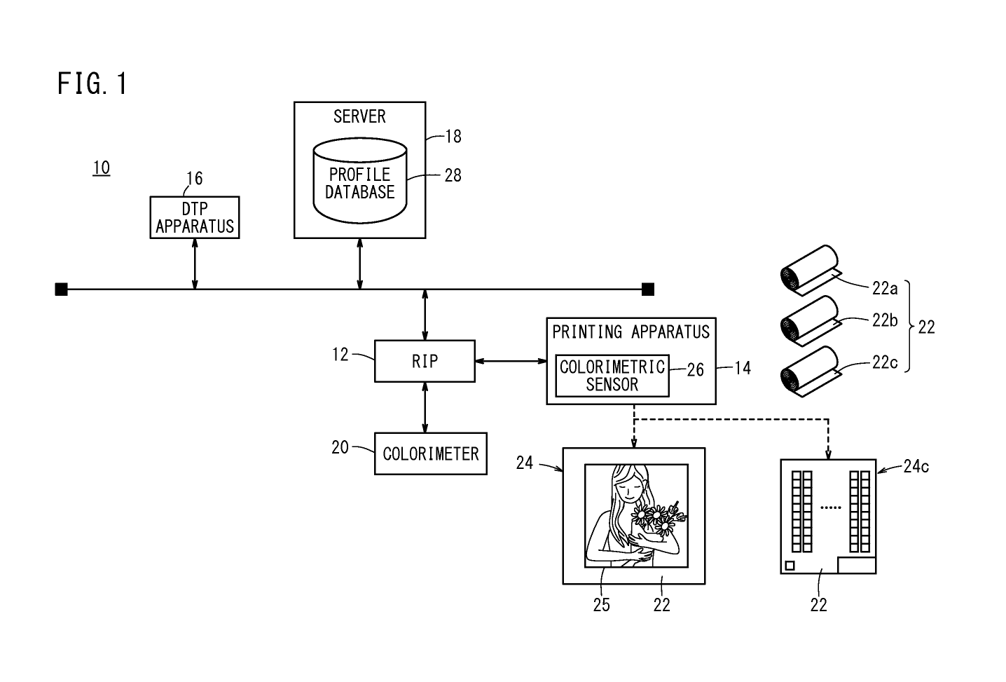

FIG. 1 shows in block form a print production system 10 incorporating therein a RIP (Raster Image Processor) 12 as a printing condition setting apparatus according to an embodiment of the present invention.

As shown in FIG. 1, the print production system 10 basically includes, in addition to the RIP 12, a printing apparatus 14, a DTP (DeskTop Publishing) apparatus 16, and a server 18. The RIP 12, the DTP apparatus 16, and the server 18 are connected to each other electrically through a wired or wireless link.

The RIP 12 converts various data (device color signals or page description data) supplied from an external apparatus into device color signals suitable for producing prints on the printing apparatus 14. The device color signals represent image data defined in device-dependent data, which may be raster-format data, such as TIFF (Tagged Image File Format) data, bitmap data, RAW data, or the like, having color channels in four colors of C, M, Y, K or three colors of R, G, B. Alternatively, the device color signals supplied to the printing apparatus 14 may have a unique data format with a desired header added thereto.

A colorimeter 20 for measuring color values of an object to be measured is connected to the RIP 12. The color values include not only tristimulus values X, Y, Z, coordinate values L*, a*, b* of a uniform color space, or the like, but also characteristics of optical physical values with respect to wavelengths, e.g., a spectral radiation distribution, a spectral sensitivity distribution, a spectral reflectance, or a spectral transmittance. Color values acquired by the colorimeter 20 may also be referred to as “colorimetric values”.

The printing apparatus 14 is connected electrically to the RIP 12 through a serial interface such as a USB (Universal Serial Bus) cable, an IEEE1394 cable, an Ethernet (registered trademark) cable, a wireless network, or the like, or a parallel interface such as a Centronics cable.

The printing apparatus 14 comprises an apparatus for forming an image on print mediums 22 (including print mediums 22a, 22b, 22c) supplied thereto, thereby producing apparatus 14 may comprise an offset press, a proofer, or a digital printer for direct printing. The proofer may comprise a DDCP (Direct Digital Color Proofer), an ink jet color proofer, a low-resolution color laser printer (electrophotographic printer), an ink jet printer, or the like. The digital printer may comprise an ink jet color proofer, a low-resolution color laser printer (electrophotographic printer), or the like.

The printing apparatus 14 is loadable with various print mediums 22 according to various standards. The printing apparatus 14 is capable of producing images on a print medium 22a (sheet A-1), a print medium 22b (sheet A-2), and a print medium 22c (sheet A-3), each of which is in the form of a roll of sheets. Each of the print mediums 22 has a base, which may comprise a paper medium such as synthetic paper, thick paper, aluminum-evaporated paper, or the like, a resin medium made of vinyl chloride, PET (polyethylene terephthalate), or the like, or tarpaulin paper, or the like. The print 24, which is produced by the printing apparatus 14, includes a finished area 25 that remains as an actual image area after marginal edges thereof have been cropped.

The printing apparatus 14 includes a colorimetric sensor 26 for measuring color values of an object to be measured. The colorimetric sensor 26 has a detection surface that faces toward an image forming surface of the print medium 22. Accordingly, the printing apparatus 14, which includes the colorimetric sensor 26, is capable of colorimetrically measuring a given area of the print medium 22 as the print medium 22 is being transported through the printing apparatus 14 by a non-illustrated transporting mechanism.

The DTP apparatus 16 generates electronic manuscripts in a page description language (hereinafter referred to as “PDL”) by laying content data made up of characters, figures, photographs, etc., on respective pages. PDL refers to a language which is descriptive of image information including format information, positional information, color information (including density information), etc., of characters, figures, etc., in a “page” that serves as an output unit for printing, displaying, or the like.

The server 18 is an apparatus for managing data concerning print jobs. More specifically, the server 18 manages data such as content data, job tickets, e.g., JDF (Job Definition Format) files, color conversion conditions, or color sample data.

The “color conversion conditions” refer to various conditions for converting a supplied image signal into device color signals for printing. The color conversion conditions may comprise not only an ICC (International Color Consortium) profile, but also a LUT (Look Up Table), matrix elements, a function formula, coefficients, various information for constructing a learning model, or any of various combinations thereof.

As shown in FIG. 1, the server 18 includes a profile database 28. The profile database 28 stores target profiles, device profiles such as printing profiles suitable for the printing apparatus 14, or device link profiles.

### [Configuration of Color Chart 24c]

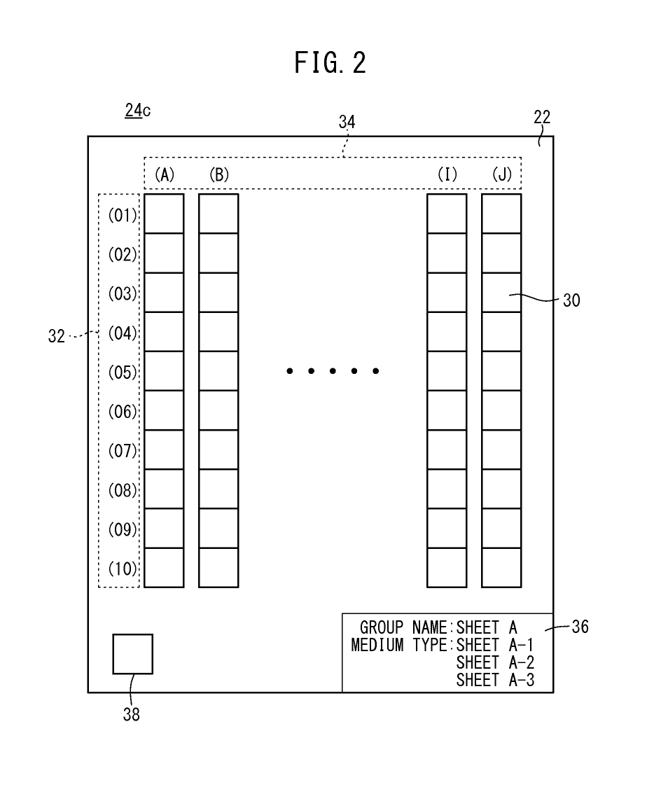

FIG. 2 is a front elevational view of the color chart 24c shown in FIG. 1. As shown in FIG. 2, the color chart 24c is made up of one hundred color patches 30 having different colors, all of which are printed on the print medium and are essentially identical in shape, a numeral string 32 for identifying rows of color patches 30, an alphabetical letter string 34 for identifying columns of color patches 30, an information field 36 printed with information concerning the type of print medium 22 (hereinafter referred to as a “medium type”), and a colorimetric frame 38 for identifying a colorimetric area on the print medium 22.

The color patches 30 are arranged in vertical columns of ten adjoined color patches, and also are arranged in horizontal rows of ten spaced color patches. The colors of the color patches 30 are set to given values in a range of signal levels of C, M, Y, K, i.e., in a range from 0% to 100%, or a gradation range of 8-bit image data from a gradation level of 0 to a gradation level of 255.

The numeral string 32 includes a downward array of numerals (01) through (10) positioned on the left side of the color patches 30 in alignment with respective horizontal rows of the color patches 30. The alphabetical letter string 34 includes a rightward array of alphabetical letters (A) through (J) positioned on the upper side of the color patches 30 in alignment with respective vertical columns of the color patches 30.

The information field 36 includes information concerning the print medium 22, e.g., a group name and medium types (sheet A-1, sheet A-2, sheet A-3) belonging to the group name. The colorimetric frame 38 surrounds a rectangular area corresponding to a base area (unprinted area) of the print medium 22.

### [Configuration of RIP 12]

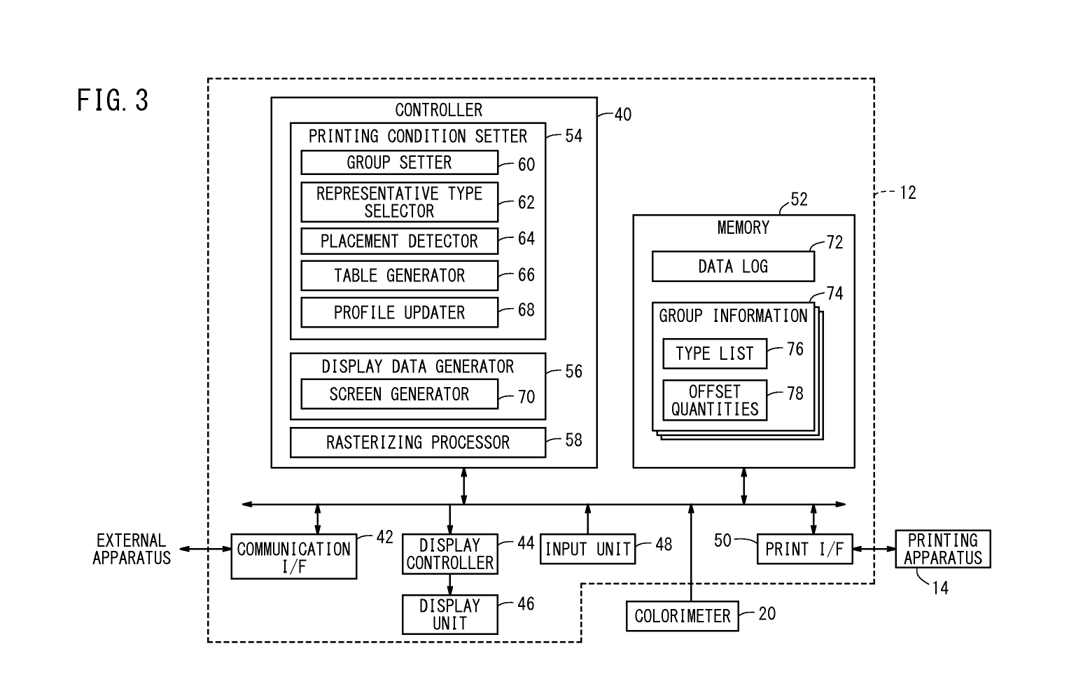

FIG. 3 is an electric block diagram of the RIP 12 shown in FIG. 1. As shown in FIG. 3, the RIP 12 comprises a computer that includes a controller 40, a communication I/F 42, a display controller 44, a display unit 46, an input unit 48, a print I/F 50, and a memory 52 (storage medium).

The communication I/F 42 comprises an interface for sending electric signals to and receiving electric signals from external apparatus. For example, the communication I/F 42 can acquire various items of information such as proof data, platemaking data, profiles, etc., which are managed and saved in the server 18 (see FIG. 1).

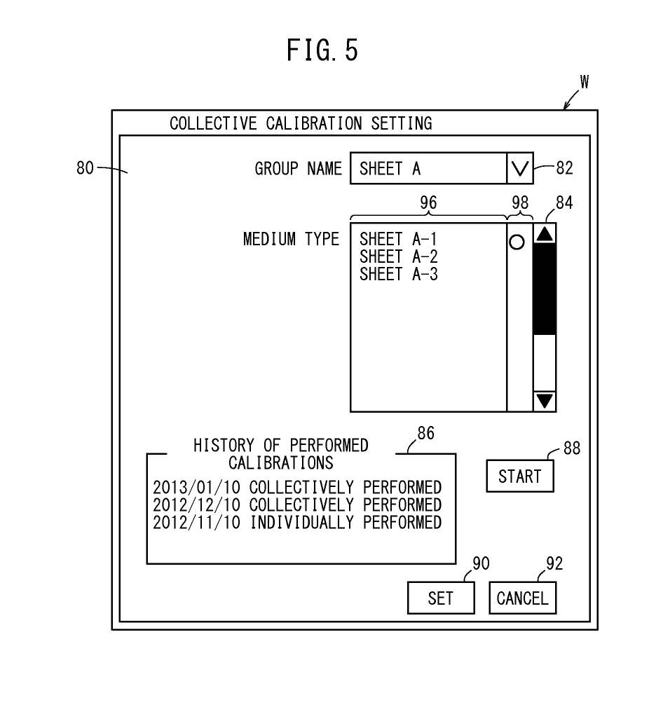

The display controller 44 comprises a control circuit for controlling the display unit 46 under the control of the controller 40. More specifically, in a case where the display controller 44 outputs a display control signal to the display unit 46 via an I/F (not shown), the display unit 46 is energized to display various images including a window W (FIG. 5).

The input unit 48 comprises various input devices including a mouse, a trackball, a keyboard, a touch sensor, etc. The display function of the display unit 46 and the input function of the input unit 48 are combined into a user interface.

The print I/F 50 comprises an interface for sending electric signals representing print data to the printing apparatus 14, and for enabling the printing apparatus 14 to produce the print 24 including the color chart 24c.

The controller 40 comprises a processor such as a CPU (Central Processing Unit). The controller 40 reads and executes programs stored in the memory 52 in order to carry out functions of a printing condition setter 54, a display data generator 56, and a rasterizing processor 58.

The printing condition setter 54 sets printing conditions including profiles for each of respective print jobs that are carried out. More specifically, the printing condition setter 54 includes a group setter 60 for setting a group of two or more medium types, a representative type selector 62 for selecting a representative type of medium from among the two or more medium types, a replacement detector 64 for detecting whether or not the print medium 22 has been replaced within a predetermined time zone, a table generator 66 for generating a color conversion table for the representative type of medium, and a profile updater 68 (color conversion condition updater) for collectively updating profiles corresponding to medium types that belong to the group set by the group setter 60.

The display data generator 56 includes a screen generator 70 for generating a setting screen 80 (see FIG. 5) for use in setting profiles.

The rasterizing processor 58 performs a rasterizing process on page description data in order to generate print data that represent an image form of the print 24. The rasterizing process includes a data format conversion process for converting a PDL format into a raster format, and a color matching process using profiles.

The memory 52 stores programs and data, which are required for the controller 40 to control various components of the RIP 12. In FIG. 3, the memory 52 stores a data log 72 including history information concerning the printing apparatus 14 and plural items of group information 74 (including a type list 76 and offset quantities 78), to be described later. The memory 52 may comprise a computer-readable non-transitory storage medium.

The computer-readable non-transitory storage medium includes a portable medium comprising a magnetooptical disk, a ROM, a CD-ROM, a flash memory, or the like, or a storage device such as a hard disk incorporated in a computer system. The storage medium may be capable of holding programs dynamically for a short period of time, or may hold programs for a prescribed period of time.

### [Operation of RIP 12]

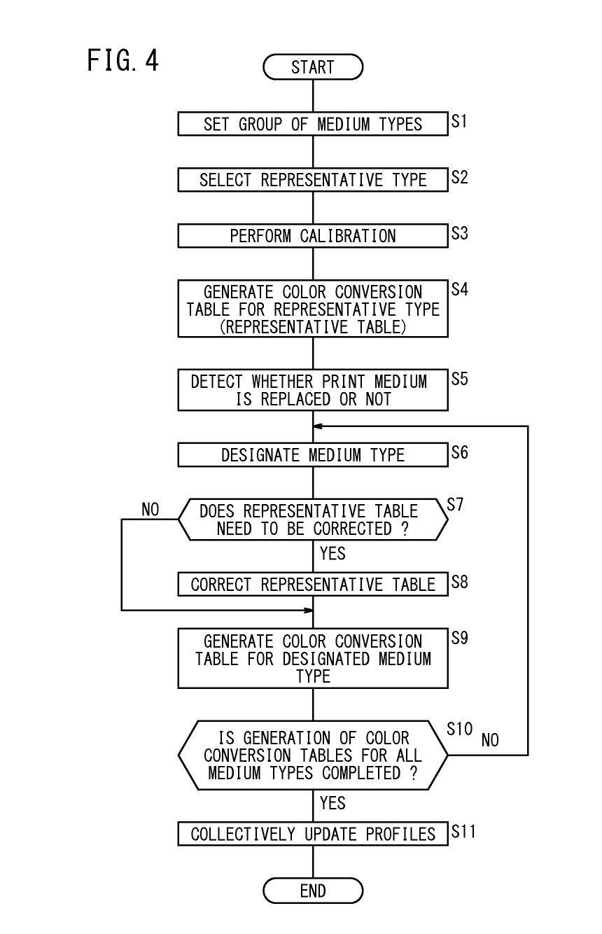

The RIP 12, which serves as a printing condition setting apparatus according to the present embodiment, is configured as described above. Operations of the RIP 12 for collectively setting a calibration (referred to as a “collective setting”) will be described below with reference to the flowchart shown in FIG. 4. According to the present embodiment, calibration (color calibration) is a concept that covers not only regeneration of profiles, but also correction of color conversion tables (tone curves). The term “collective setting” refers to a setting process that classifies print mediums 22 having highly correlated color reproduction characteristics into a group, and reflects the calibration results using a representative type of print medium 22 for the remaining other types of print mediums 22.

In step S1 of FIG. 4, the group setter 60 sets a group of two or more medium types from among a plurality of medium types. More specifically, the group setter 60 classifies medium types, the color reproduction characteristics of which on prints 24 are highly correlated, and the color prediction precision levels of which are relatively high, into a group. In the following description, it is assumed that the group setter 60 classifies three medium types, i.e., “SHEET A-1”, “SHEET A-2”, and “SHEET A-3”, into a group under the name “SHEET A”.

In step S2, the representative type selector 62 selects a representative type from among two or more medium types that belong to the group set in step S1. It is assumed that the medium type “SHEET A-1” of the print medium 22a is selected as the representative type from among the medium types “SHEET A-1”, “SHEET A-2”, and “SHEET A-3”.

The term “representative type” refers to a type of print medium 22 on which the color chart 24c is printed and actually measured colorimetrically. In other words, the term “representative type” refers to a medium type that is used in a calibration process performed on the printing apparatus 14.

Then, the controller 40 stores group information 74 concerning the group “SHEET A” in the memory 52. The group information 74 includes a type list 76 representing the group name and a list of medium types that belong to the group, and offset quantities 78 of the color reproduction characteristics of the remaining medium types with respect to the color reproduction characteristics of the representative type.

In step S3, the RIP 12 performs a calibration using the print medium 22 of the representative type, which was selected in step S2. Prior to performing the calibration, the RIP 12 displays a setting screen 80 (see FIG. 5) for use in setting profiles. More specifically, in response to an instruction to start setting profiles, the screen generator 70 of the display data generator 56 generates display data for the setting screen 80, and supplies the generated display data to the display controller 44. The display controller 44 controls the display unit 46 to display a window W including the setting screen 80 shown in FIG. 5.

As shown in FIG. 5, the setting screen 80 includes a group selection field 82, a first display field 84, a second display field 86, a button 88 labeled “START”, and buttons 90, 92 labeled “SET” and “CANCEL”, respectively. The first display field 84 is made up of a small field 96 indicating a list of medium types that belong to the group name indicated by the group selection field 82, and a small field 98 including a mark (the circular dot in FIG. 5) that specifies the representative type. The second display field 86 indicates a history of calibrations (dates and updating processes) that have been performed.

The operator, who is a user of the print production system 10, sets “SHEET A” in the group selection field 82, and then clicks on the “START” button 88. In response to the operator clicking on the “START” button 88, the controller 40 of the RIP 12 initiates a calibration process using the print medium 22a, which is of the representative type “SHEET A-1”. For example, the controller 40 instructs the printing apparatus 14 to produce the color chart 24c (FIG. 2), and acquires colorimetric values of the color patches 30 from the colorimeter 20.

In step S4, the table generator 66 generates color conversion conditions for the representative type (hereinafter referred to as “representative conditions”) based on the results of the calibration performed in step S3. More specifically, according to a known computational process, the table generator 66 generates a color conversion table (hereinafter referred to as a “representative table”) depending on the relationship between device color signals and colorimetric values of the color patches 30.

In step S5, the replacement detector 64 detects whether or not the print medium 22 has been replaced with a print medium of the same medium type within a predetermined time zone. The print medium 22 may be replaced either “physically” or “operationally” according to agreements reached by the user. The replacement detector 64 may detect whether or not the print medium 22 has been replaced by analyzing the data log 72, which represents events that occurred in the printing apparatus 14 and information concerning times at which the events occurred, or by acquiring various information in accordance with manual actions entered by the user through the input unit 48.

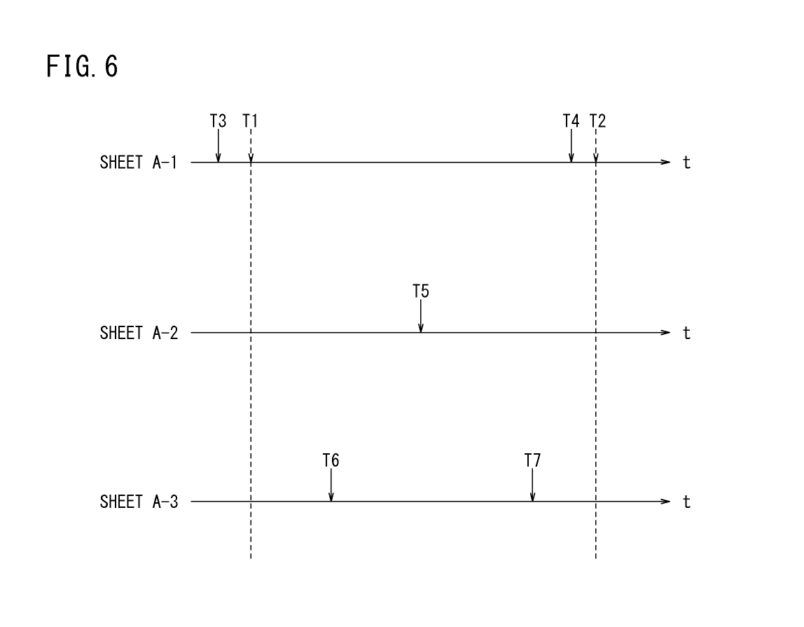

FIG. 6 is a time sequence diagram showing times at which calibrations are performed and times at which a print medium is replaced. In FIG. 6, the arrows on the time axes of the respective medium types represent times at which events occur. The solid-line arrows represent times at which the print medium 22 is replaced, and the broken-line arrows represent calibration execution times.

As shown in FIG. 6, a calibration is executed at time t=T1 and at time t=T2 using the print medium 22a of the representative type. The print medium 22a (SHEET A-1) is replaced at time t=T3 and at time t=T4 immediately prior to execution of a calibration. The print medium 22b (SHEET A-2) is replaced at time t=T5 (T1<T5<T2). The print medium 22c (SHEET A-3) is replaced at time t=T6 and at time t=T7 (T1<T6<T7<T2).

The replacement detector 64 detects that the print mediums 22a, 22b, 22c are replaced during a period of time from time t=T1, which corresponds to a preceding calibration execution time, to time t=T2, which corresponds to a present calibration execution time.

In step S6, the printing condition setter 54 designates another medium type which has not yet been designated (hereinafter referred to as a “designated medium type”) from among two or more medium types that belong to the group set in step S1. It is assumed that the printing condition setter 54 designates “SHEET A-2” as one of the other medium types.

In step S7, the profile updater 68 determines whether or not the representative table needs to be corrected depending on the result detected in step S5. If the representative table needs to be corrected (step S7: YES), then control proceeds to step S8. If the representative table does not need to be corrected (step S7: NO), then control skips over step S8.

In step S8, the profile updater 68 corrects the representative table that was generated in step S4, so as to cancel out color fluctuations caused after the print medium 22 has been replaced, thereby appropriately removing color fluctuation factors governed by the production lot of the print medium 22, the time at which the print medium 22 is obtained (including the number of days that have elapsed after production of the print medium 22), and the state in which the print medium 22 has been stored. A process of correcting the representative table will be described in detail below. There are four examples of processes for correcting the representative table. These examples will be described in succession below.

According to the first example, it is presumed that a fixed fluctuating factor is developed due to differences between production lots of print mediums 22a in the event that color fluctuations in preceding and present calibrations are greater than a predetermined threshold value and the representative type is detected as being replaced. In the first example, the profile updater 68 corrects the representative table generated in step S4 so as to cancel out (by way of addition or subtraction) color fluctuations caused after the print medium 22a has been replaced.

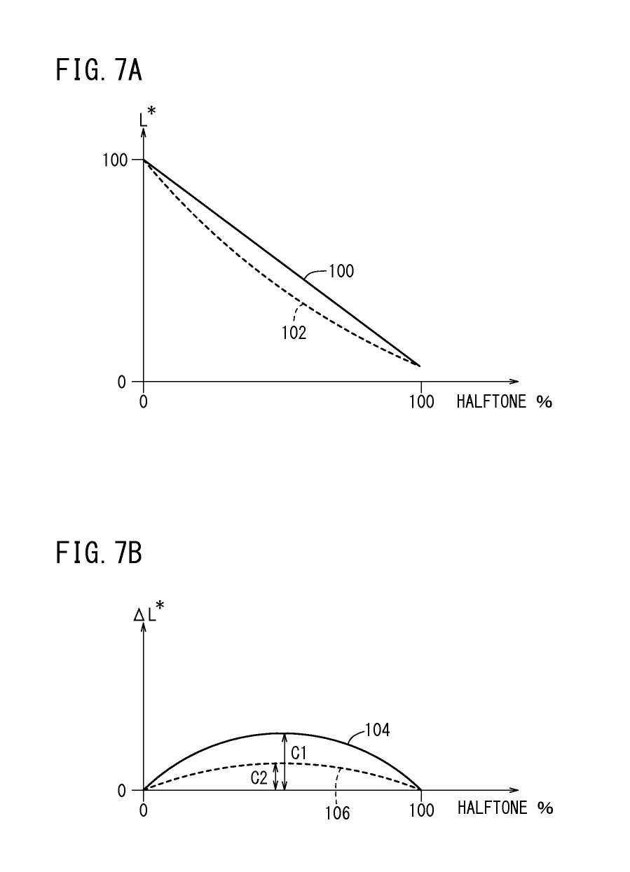

FIG. 7A is a graph showing color reproduction characteristics obtained in the case that print mediums 22 of one medium type are used. The graph has a horizontal axis representing input gradation values, which are expressed as a halftone percentage % in FIG. 7A, and a vertical axis representing color values, which are expressed in terms of lightness L* in FIG. 7A. The solid-line curve in the graph represents a preceding representative table 100, which is obtained by a calibration carried out at the preceding execution time t=T1, and the broken-line curve in the graph represents a present representative table 102, which is obtained by a calibration carried out at the present execution time t=T2. A comparison between the preceding representative table 100 and the present representative table 102 reveals that color fluctuations between the tables are maximum in a medium gradation range of about 50%.

FIG. 7B is a graph showing by way of example corrective quantities 104, 106 determined in view of the difference between the color reproduction characteristic curves shown in FIG. 7A. The graph has a horizontal axis representing input gradation values, which are expressed as a halftone percentage %, and a vertical axis representing corrective quantities, which are expressed in terms of a change in lightness ΔL* for the color values. The preceding representative table 100 (FIG. 7A) can essentially be reproduced by adding the corrective quantity 104, which is expressed by the solid-line curve, to the present representative table 102 (FIG. 7A). Stated otherwise, by applying a corrected representative table, it is possible for the result of a calibration to be reflected therein, with the fixed fluctuating factor being appropriately removed in print mediums 22b, 22c of the other medium types.

According to the second example, it is presumed that a temporal fluctuating factor is developed due to a change in quality of the print medium 22a in the event that color fluctuations in preceding and present calibrations are greater than a predetermined threshold value and the representative type is not detected as being replaced. If another medium type is detected as being replaced, then the effect on the print mediums 22b, 22c is estimated as being smaller than the effect on the print medium 22a. If another medium type is detected as being replaced, the profile updater 68 adds color fluctuations (the corrective quantity 106 in FIG. 7B), which are smaller than the color fluctuations (the corrective quantity 104 in FIG. 7B) caused after the print medium 22a was replaced, thereby correcting the present representative table 102.

If the corrective quantities 104, 106 have respective values C1, C2 at a certain halftone percentage %, then the corrective quantity C2 for the print medium 22b (SHEET A-2) may be determined by the formula C2=C1·(T2−T5)/(T2−T1) according to a linear model. By applying the representative table, which is corrected in the foregoing manner, it is possible for the result of a calibration to be reflected therein, with the temporal fluctuating factor being appropriately removed in the print mediums 22b, 22c of the other medium types.

According to the third example, it is presumed that a fixed fluctuating factor is developed due to a difference between production lots of print mediums 22a, in the case that another medium type is detected as being replaced and color fluctuations after replacement of the medium type are greater than a predetermined threshold value. In the third example, similar to the case of the first example, the profile updater 68 may correct the representative table by canceling out (by way of addition or subtraction) color fluctuations caused after the print mediums 22b, 22c have been replaced.

According to the fourth example, the profile updater 68 may correct the representative table, which has been corrected so as to cancel out (by way of addition or subtraction) color fluctuations caused after the print mediums 22b, 22c have been replaced, in the case that the representative type and another medium type are detected as being replaced.

In the first, third, and fourth examples, color fluctuations may be represented by a color difference of the base of the print medium before and after the print medium is replaced. For printing the color chart 24c, the printing apparatus 14 shown in FIG. 1 acquires by way of the colorimetric sensor 26 colorimetric values of the base of the print medium 22 within the colorimetric frame 38, and then supplies the acquired colorimetric values to the RIP 12 while the print medium 22 is being transported. The profile updater 68 corrects the present representative table 102 using the color difference of the base of the print medium 22. Alternatively, the profile updater 68 may store the color of the base of the print medium 22 in association with an identification number (including the production lot number) of the print medium 22, and read colorimetric values corresponding to the identification number acquired upon replacement of the print medium 22.

In step S9, the profile updater 68 generates a color conversion table for the designated medium type, using the representative table that was generated in step S4 or corrected in step S8. More specifically, the profile updater 68 adds the offset quantities 78 read from the memory 52 to the generated or corrected representative table, thereby calculating color conversion tables corresponding to the medium types registered in the type list 76.

In step S10, the printing condition setter 54 determines whether or not generation of color conversion tables for all of the medium types that belong to the group has been completed. If the printing condition setter 54 determines that generation of color conversion tables has not been completed, then control returns to step S6 and steps S6 through S9 are repeated. If the printing condition setter 54 determines that generation of the color conversion tables has been completed, then control proceeds to step S11.

In step S11, the profile updater 68 collectively updates the profiles corresponding to all of the medium types that belong to the same group as the representative type.

Operations of the RIP 12 with respect to setting of calibrations are now completed. In response to the operator clicking on the “SET” button 90 (FIG. 5), the RIP 12 sends the new profiles to the server 18 in order to update the profile data in the profile database 28 (FIG. 1).

### Advantages of the Invention

As described above, the RIP 12 includes the representative type selector 62 that selects a representative type to be used in a calibration performed on the printing apparatus 14 from among two or more medium types that have been classified into a group, the replacement detector 64 that detects whether or not the print medium 22 supplied to the printing apparatus 14 has been replaced with a print medium of the same medium type within a period of time from a preceding calibration execution time T1 to a present calibration execution time T2, and the profile updater 68 that corrects representative conditions, which are color conversion conditions corresponding to the representative type that are obtained at the present calibration execution time T2, depending on the detected result from the replacement detector 64, and collectively updates color conversion conditions corresponding to two or more medium types belonging to the same group as the representative type, based on the corrected representative conditions.

Since it is detected whether or not the print medium 22 supplied to the printing apparatus 14 has been replaced with a print medium of the same medium type within a period of time from a preceding calibration execution time T1 to a present calibration execution time T2, and representative conditions that are obtained at the present calibration execution time T2 are corrected depending on the detected result, a change in color reproduction characteristics caused by replacement of the print medium 22 can be reflected not only in the representative type, but also in calibrations that are performed on the other medium types. Further, since color conversion conditions corresponding to two or more medium types that belong to the same group as the representative type are corrected collectively based on the corrected representative conditions, the number of calibrations that are required to be carried out can be reduced to one per group. Consequently, it is possible to minimize the number of required calibration process steps, while at the same time maintaining a desired level of color precision management for prints 24 using print mediums 22 of the same medium type.

Although a certain preferred embodiment of the present invention has been shown and described in detail, it should be understood that various changes and modifications may be made to the embodiment without departing from the scope of the invention as set forth in the appended claims.

What is claimed is:

1. A printing condition setting apparatus for setting color conversion conditions for respective types of print mediums on which an image is produced with a printing apparatus, comprising:
a representative type selector for selecting a representative type to be used in a calibration on the printing apparatus from among two or more medium types that have been classified into a group;
a replacement detector for detecting whether or not the print medium supplied to the printing apparatus has been replaced with a print medium of the same medium type within a period of time from a preceding calibration execution time to a present calibration execution time; and
a color conversion condition updater for correcting a representative condition, which is a color conversion condition corresponding to the representative type that is obtained at the present calibration execution time, depending on a detected result from the replacement detector, and collectively updating color conversion conditions corresponding to two or more medium types that belong to the same group as the representative type, based on the corrected representative condition.

2. The printing condition setting apparatus according to claim 1, wherein the replacement detector detects whether or not the print medium of the representative type has been replaced; and
the color conversion condition updater corrects the representative condition so as to cancel out a color fluctuation after the print medium of the representative type has been replaced, and collectively updates the color conversion conditions, if the print medium of the representative type is detected as being replaced.

3. The printing condition setting apparatus according to claim 2, wherein the replacement detector detects whether or not a print medium of another medium type apart from the representative type has been replaced; and
the color conversion condition updater corrects the corrected representative condition so as to cancel out a color fluctuation caused after the print medium of the other medium type has been replaced, and collectively updates the color conversion conditions, if the print medium of the representative type is detected as being replaced and the print medium of the other medium type is detected as being replaced.

4. The printing condition setting apparatus according to claim 1, wherein the replacement detector detects whether or not a print medium of another medium type apart from the representative type has been replaced; and
the color conversion condition updater corrects the representative condition so as to cancel out a color fluctuation caused after the print medium of the other medium type has been replaced, and collectively updates the color conversion conditions, if the print medium of the other medium type is detected as being replaced.

5. The printing condition setting apparatus according to claim 2, wherein the color fluctuation is represented by a color difference of a base of the print medium before and after the print medium is replaced.

6. A printing condition setting method to be carried out by a printing condition setting apparatus for setting color conversion conditions for respective types of print mediums on which an image is produced with a printing apparatus, comprising the steps of:
selecting a representative type to be used in a calibration on the printing apparatus from among two or more medium types that have been classified into a group;
detecting whether or not the print medium supplied to the printing apparatus has been replaced with a print medium of the same medium type within a period of time from a preceding calibration execution time to a present calibration execution time; and
correcting a representative condition, which is a color conversion condition corresponding to the representative type that is obtained at the present calibration execution time, depending on a detected result from the step of detecting, and collectively updating color conversion conditions corresponding to two or more medium types that belong to the same group as the representative type, based on the corrected representative condition.

7. The printing condition setting method according to claim 6, wherein
the step of detecting detects whether or not the print medium of the representative type has been replaced; and
the step of correcting corrects the representative condition so as to cancel out a color fluctuation after the print medium of the representative type has been replaced, and collectively updates the color conversion conditions, if the print medium of the representative type is detected as being replaced.

8. The printing condition setting method according to claim 7, wherein
the step of detecting detects whether or not a print medium of another medium type apart from the representative type has been replaced; and
the step of correcting corrects the corrected representative condition so as to cancel out the color fluctuation caused after the print medium of the other medium type has been replaced, and collectively updates the color conversion conditions, if the print medium of the representative type is detected as being replaced and the print medium of the other medium type is detected as being replaced.

9. The printing condition setting method according to claim 6, wherein
the step of detecting detects whether or not a print medium of another medium type apart from the representative type has been replaced; and
the step of correcting corrects the corrected representative condition so as to cancel out a color fluctuation caused after the print medium of the other medium type has been replaced, and collectively updates the color conversion conditions, if the print medium of the other medium type is detected as being replaced.

10. The printing condition setting method according to claim 7, wherein the color fluctuation is represented by a color difference of a base of the print medium before and after the print medium is replaced.

11. A non-transitory storage medium storing therein a program for setting color conversion conditions for respective types of print mediums on which an image is produced with a printing apparatus, the program enabling a computer to carry out the steps of:
selecting a representative type to be used in a calibration on the printing apparatus from among two or more medium types that have been classified into a group;
detecting whether or not the print medium supplied to the printing apparatus has been replaced with a print medium of the same medium type within a period of time from a preceding calibration execution time to a present calibration execution time; and
correcting a representative condition, which is a color conversion condition corresponding to the representative type that is obtained at the present calibration execution time, depending on a detected result from the step of detecting, and collectively updating color conversion conditions corresponding to two or more medium types that belong to the same group as the representative type, based on the corrected representative condition.
